(19) United States
(12) Patent Application Publication
(10) Pub. No.: US 2003/0072118 A1
(43) Pub. Date: Apr. 17, 2003

(54) Receptable with overload protect

(76) Inventor: Chien-Chi Chou, Taipei Hsien (TW)

Correspondence Address: BRUCE H. TROXELL, SUITE 1404, 5205 LEESBURG PIKE, FALLS CHURCH, VA, 22041, US

(21) Appl. No.: 09/996,811

(22) Filed: Nov. 30, 2001

(30) Foreign Application Priority Data
Oct. 11, 2001 (TW) 090217315

(51) Int. Cl. H02H 3/08

(52) U.S. Cl. 361/93.1

(57) ABSTRACT

A receptacle with overload protect comprises an upper cover, a printed circuit board, and a lower cover. The upper cover at least has a pair of outlet slots and the printed circuit board provides at least an outlet corresponding to the outlet slots. The lower cover provides a plug so that the alternate current source can be connected to the printed circuit board as soon as the plug is inserted into a foreign outlet. Hence, the receptacle with overload protect can perform leakage detection, instantly break of secondary end load protection and automatically switching over AC 110V˜220V/15A in addition to the overload protect.

### BACKGROUND OF THE INVENTION

1. Field of The Invention

The present invention relates to a receptacle with protection from overload, and, particularly, to a receptacle, which provides multiple outlets and an arrangement to prevent from overload.

2. Description of Related Art

Due to the progress of technology, various information products, home electrical appliances, and consumptive electronic products are available on the market. The consumers always find outlets in their house insufficient after the electrical or the electronic products being bought. Usually, there are two ways adopted to solve the problem of insufficient outlets, extending cord with a receptacle and multi outlets. Although the extending cord with receptacle can make up a deficiency of original outlets in the house, a mess of electrical cords is not suitable for a small space offered and it is not pleasing to the eye. As for the conventional multi outlet receptacle, it certainly can increase the number of the outlets needed but the multi outlets has to be plugged to an original outlet in the house before using such that it is very possible to occur overloading to burn out the electronic products or to occur accidental sparking, which may result in a fire.

### SUMMARY OF THE INVENTION

An receptacle with overload protect according to the present invention comprises an upper cover, a printed circuit board, and a lower cover. The upper cover at least has a pair of outlet slots and the printed circuit board provides at least an outlet corresponding to the outlet slots. The lower cover provides a plug so that the alternate current source can be connected to the printed circuit board as soon as the plug is inserted into a foreign outlet.

Accordingly, an object of the present invention is to provide a receptacle with overload protect, which can protect the circuit in the receptacle from overload, high sensitivity of leakage detection, instantly breaking secondary end load and automatically switching over 110˜220/15 A alternate current secondary end load.

### BRIEF DESCRIPTION OF THE DRAWINGS

The present invention can be more fully understood by reference to the following description and accompanying drawings, in which:

FIG. 1 shows a front view, a top view and a side view of a receptacle with overload protect according to the present invention in an embodiment thereof;

FIG. 2 is a disassembled plan view of the embodiment shown in FIG. 1;

FIG. 3 is a block diagram illustrating a print circuit board in the embodiment; and

FIG. 4 is a block diagram illustrating a print circuit board in another embodiment.

### DETAILED DESCRIPTION OF THE PREFERRED EMBODIMENTS

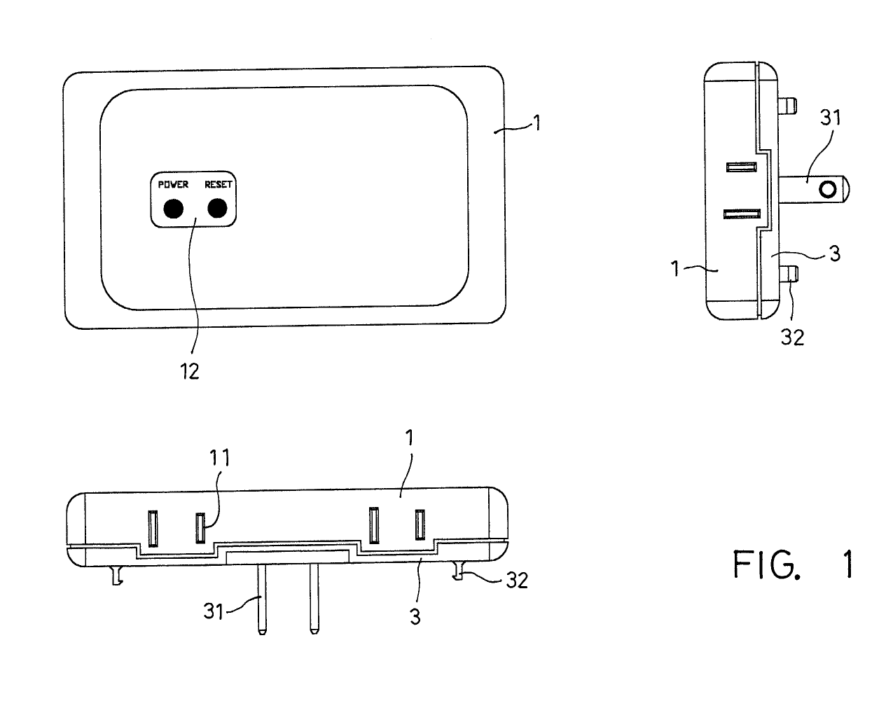

Referring to FIG. 1, a receptacle with overload protect according to the present invention provides at least one outlet and it can be seen in the figure that two opposite long lateral sides thereof have two outlets respectively and two opposite short lateral sides have an outlet respectively. It is noted that the outlets arranged in the figure are for taking an example and other arrangement for the outlets can be used also. The top view of the embodiment shows a power indicating light and a reset indicating light so that the operation of the receptacle can be indicated.

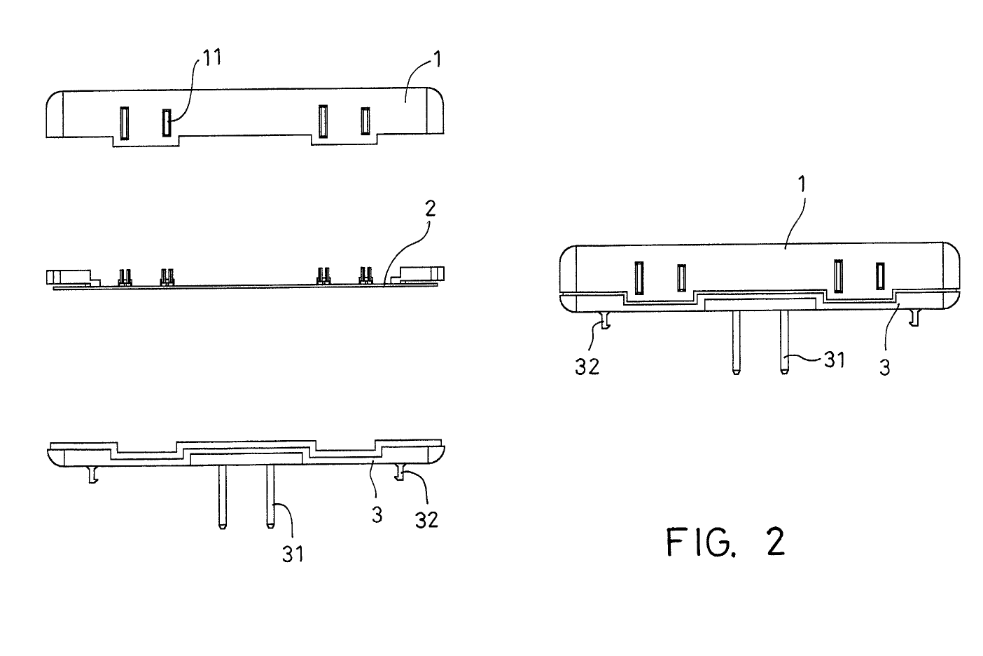

Referring to FIG. 2, the receptacle with overload protect according to the present invention comprises an upper cover 1 with at least two pairs of outlet slots 11, a printed circuit board 2 and a lower cover 3. In order to be identified, the upper cover 1 at a facial panel thereof can be arranged with an indicating light part 12, and the upper cover 1 itself is preferably made of fluorescent material. The lower cover 3 provides a plug part 31 so that the alternate current power source can be coupled to the printed circuit board 2 as soon as the plug 31 is inserted into a power source inlet of 110˜220V/15 A/60 Hz alternate current (not shown). Hence, a receptacle with overload protect of the present invention can be formed to be free from overload and possible to detect the electrical leakage. Besides, the lower cover 3 provides two opposite engaging hooks 32 to engage with two opposite engaging holes in the power source outlet once the outer cover of the power source outlet has been removed.

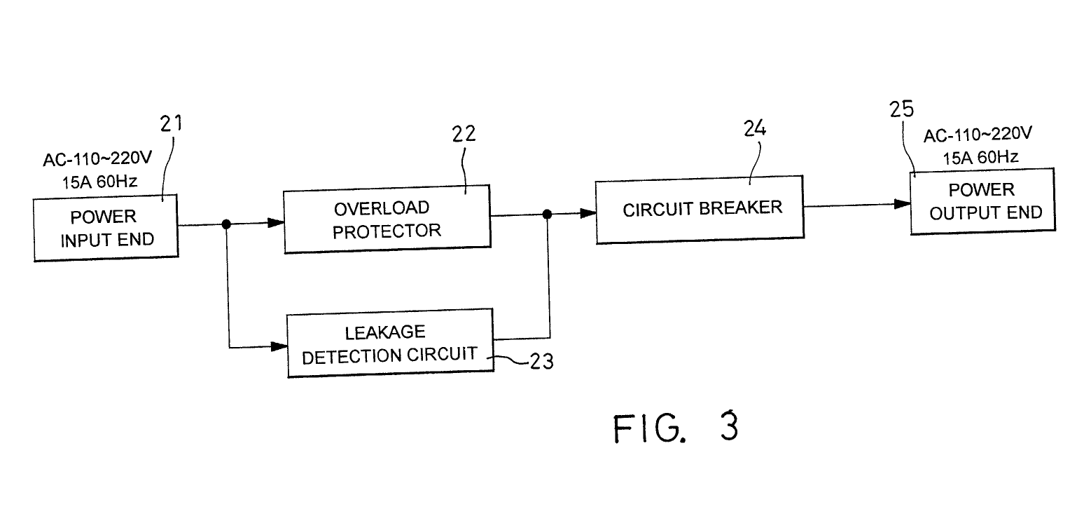

Referring to FIG. 3, the printed circuit board 2 in the preceding embodiment of the present invention comprises a power input end 21, an overload protector 22, a leakage detection circuit 23, a circuit breaker 24, and a power output end 25. The power input end 21 couples with the plug 31 to supply 110˜220V/15 A/60 Hz alternate current. The overload protector 22 is connected to the power input end 21 to detect if the circuit in the printed circuit board 2 is in a state of overload. Further, the leakage detection circuit 23 is connected to the power input end too to detect if the circuit is in a state of electrical leakage. The circuit breaker 24 is connected to both of the overload protector 22 and the leakage detection circuit 23 such that the circuit breaker 24 can make a break to cease the power output of the alternate current in case of occurring an overload circuit or an electrical leakage so that the electronic product being powered on via the receptacle of the present invention can avoid being burned out. The power output end 25 is connected to the circuit breaker 24 to output 110˜220V/15 A/60 Hz alternate current.

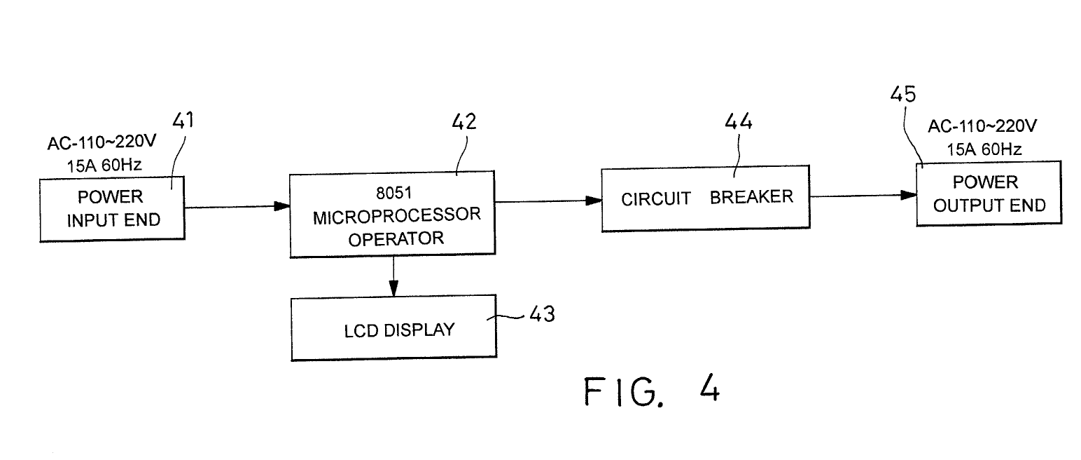

Referring to FIG. 4, another embodiment with regard to the circuit in the printed circuit board 2 comprises a power input end 41, a microprocessor 42, a LCD display 43, a circuit breaker 44 and a power output end 45. The power input end 41 couples with the plug 31 to input the alternate current. The microprocessor 42 is connected to the power input end 41 to detect if the circuit is in a state of overload or leakage. The LCD display 43 is connected to the microprocessor 42 to show the result detected by the microprocessor 42. The circuit breaker 44 is connected to the microprocessor 42 such that the circuit breaker 44 can make a break in case of an overload circuit or an electrical leakage. The power output end 45 connects with the circuit breaker 44 to output the alternate current coming from the input end 41. The microprocessor 42 is 8051 chip and it is possible to restore the supply of the alternate current as soon as the circuit breaker 44 is reset after the malfunction having been removed.

It is appreciated from the foregoing that the present invention offers the following advantages: preventing the circuit in the receptacle from overload, high sensitivity leakage detection, instant break for secondary end load and automatically switching over 110˜220/15 A alternate current. Hence, the user can use multiple electronic products safely without the need of worrying about if the circuit is overload, if the expensive electronic product might be burned out and the hazard of fire might occur resulting from electric wire sparking. Therefore, the receptacle with overload protect of the present invention performs functions not possible reached by the prior art.

While the invention has been described with reference to a preferred embodiment thereof, it is to be understood that modifications or variations may be easily made without departing from the spirit of this invention, which is defined in the appended claims.

What is claimed is:

1. A receptacle with overload protect, comprising:
an upper cover, providing at least one pair of outlet slots;
a printed circuit board, providing at least one outlet corresponding to the outlet; and
a lower cover, providing a plug to be inserted into a power source outlet for an alternate current power source being able to connect with the printed circuit board;
whereby, the printed circuit board is sandwiched between the upper and the lower covers to perform a protection from overload.

2. The receptacle with overload protect according to claim 1, wherein the upper cover further comprises a power indicating light and a reset indicating light.

3. The receptacle with overload protect according to claim 1, wherein the printed circuit board further comprises:
a power input end, coupling with the plug admitting the alternate current power source;
a circuit protector, being connected to the power input end for detecting if the alternate current power source is overload;
a leakage detection circuit, being connected to the power input end for detecting if an electrical leakage occurs;
a circuit breaker, being connected to the circuit protector and to the leakage protection circuit for making a break in case of overload or leakage; and
a power output end, connecting with the circuit breaker for outputting the alternate current power source.

4. The receptacle with overload protect according to claim 3, wherein the power input end can switch over the alternate current source from 110V to 220V or from 220V to 110V automatically.

5. The receptacle with overload protect according to claim 1, wherein the printed circuit board further comprises:
a power input end, being connected to the plug for admitting the alternate current source;
a microprocessor, being connected to the power input end for detecting if an overload or a leakage occur;
a LCD display, being connected to the microprocessor for showing a detected result of the microprocessor;
a circuit breaker, being connected to the microprocessor for making a break in case of an overload or an electrical leakage; and
a power output end, being connected to the circuit breaker for outputting the alternate current source;
whereby, the microprocessor can restore a supply of the alternate current by way of resetting the circuit breaker after a malfunction being removed.

6. The receptacle with overload protect according to claim 5, wherein the power input end can switch over the alternate current source from 110V to 220V or from 220V to 110V automatically.

7. The receptacle with overload protect according to claim 5, wherein the microprocessor is a 8051 chip.

8. The receptacle with overload protect according to claim 1, wherein the lower cover may provide two opposite engaging hooks to engage with engaging holes in the foreign socket.

9. The receptacle with overload protect according to claim 1, wherein the upper cover provides a top panel with indicating lights.

10. The receptacle with overload protect according to claim 1, wherein the upper cover may be made of fluorescent material.
